(19) United States
(12) Patent Application Publication
(10) Pub. No.: US 2013/0290819 A1
(43) Pub. Date: Oct. 31, 2013

(54) LITERARY GENRE MAP AND METHODS OF USE THEREOF

(71) Applicant: PENGUIN GROUP (USA) INC., New York, NY (US)

(72) Inventor: Molly Barton, Staten Island, NY (US)

(73) Assignee: PENGUIN GROUP (USA) INC., New York, NY (US)

(21) Appl. No.: 13/871,340

(22) Filed: Apr. 26, 2013

Related U.S. Application Data
(60) Provisional application No. 61/638,784, filed on Apr. 26, 2012.

(51) Int. Cl. G06F 17/27

(52) U.S. Cl. CPC G06F 17/27
USPC 715/201

(57) ABSTRACT

A method of displaying an electronic book includes techniques for allowing a person to self-publish an electronic book by employing tones of the electronic book and displaying the book on a two-dimensional graphical book map in which the location of the book on the map is based on the identified tones and degrees of those tones. A genre map including various book genres and subgenres also are employed. A person desiring to find a book having desired tones/characteristics uses the genre map and then the displayed graphical book map.

### REFERENCE TO RELATED APPLICATION

This application claims priority, under 35 U.S.C. §119(e), to U.S. Provisional Patent Application No. 61/638,784, filed in the United States Patent and Trademark Office on Apr. 26, 2012, the entire disclosure of which is incorporated herein by reference.

### FIELD OF THE INVENTION

The present invention relates generally to an apparatus and method of self-publishing books and searching for and reading self-published books and, more particularly, to a method and apparatus that allows for the intuitive publication and searching of book using a literary genre map.

### BACKGROUND OF THE INVENTION

An electronic book (e-book) is generally a book-length publication in digital form, consisting of text, images, or both, which may be produced on, published through and readable on a computer or other electronic device such as electronic book readers (e-readers) or smart phones.

The e-book is becoming more and more popular since the advent of the Internet. When a user wishes to purchase or otherwise obtain an e-book, he/she may generally do so directly through the e-reader or other device by downloading the e-book onto the e-reader via the Internet.

Self-publishing is the publication of a book (or other media) by the author of the work, without involving a publisher. The author generally is responsible for the entire process including the design, format, price, distribution, marketing and public relations.

There is a problem with self-publishing in that it is difficult for the self-publisher to get his/her book in the hands of readers who may enjoy that genre of book. And there is a related problem of readers interested in reading self-published books finding such books.

### SUMMARY OF THE INVENTION

In view of the foregoing, it is an object of the present invention to provide a method of publishing and searching for e-books. More specifically, the present invention provides a method that employs graphical maps to enable individuals to (self) publish and for readers to search for e-books having desired characteristics.

To achieve the foregoing and other objects, an embodiment of the present invention entails a method of displaying an electronic book, comprising the steps of receiving, from a person desiring to publish a book, a degree of an identified tone of the book to be electronically received and placed on a graphical book map, receiving an electronic copy of the book via an electronic communication, and providing a graphical book map for display on an electronic device, the graphical book map having a graphical representation of the received book disposed at a location on the graphical book map based on the received degree of the identified tone of the book.

Another embodiment of the present invention entails a method of displaying an electronic book, comprising the steps of providing a graphical genre map for display on an electronic device, the graphical genre map including a plurality of book genres, receiving an identification of a selected one of the book genres, providing for display on the electronic device, after receiving the selected book genre, a graphical book map corresponding to the selected book genre, the graphical book map including graphical representations of a plurality of books, each of the graphical representations disposed at a respective location on the graphical book map based on degrees of tones of the respective book, and receiving a selection of one of the books graphically represented in the graphical book map.

Yet another embodiment of the present invention entails a method of displaying an electronic book by an author or other person desiring to publish a book following by readers seeking to find desired books, in which the method comprises the steps of providing a graphical genre map for display on an electronic device viewable by a person desiring to publish an electronic book, the graphical genre map including a plurality of book genres, receiving, from the person, an identification of a selected one of the book genres, receiving, from the person, a degree of an identified tone of the electronic book, receiving, from the person, an electronic copy of the electronic book via an electronic communication, providing for display on the electronic device a graphical book map having a graphical representation of the received book disposed at a location on the graphical book map based on the received degree of the identified tone of the book, providing the graphical genre map for display on another electronic device viewable by a reader desiring to find a book to read, the displayed graphical genre map including a plurality of book genres, receiving, by the reader, an identification of a selected one of the book genres, providing for display on the another electronic device, after receiving the selected book genre, a graphical book map corresponding to the selected book genre, the graphical book map including graphical representations of a plurality of books, each of the graphical representations disposed at a respective location on the graphical book map based on degrees of tones of the respective book, receiving, from the reader, a selection of one of the books graphically represented in the graphical book map, and providing, to the reader, information about the selected book.

Yet a further embodiment of the present invention includes a non-transitory computer-readable recording medium having recorded thereon a computer program for executing any of the above-summarized methods.

For each of the above-summarized methods, various aspects and features, as appropriate, are summarized as follows.

As one aspect of the invention, the graphical book map includes graphical representations of other electronic books received via electronic communication, the respective locations of the graphical representations of the other electronic books being based on respective identified degrees of tones of the other electronic books.

As another aspect, the graphical book map further includes a graphical representation of at least one well-known book at a location on the graphical book map that is based on a degree of a tone of the well-known book, the graphical representation of the well-known book being different than the graphical representation of the received electronic book, and being provided to assist the self-publisher, reader or other person to identify characteristics of a book to be self-published or to assist in identifying one or more books identified in the graphical book map with desired characteristics/tones.

As yet a further aspect, plural tones of the book and degrees of those plural tones are received, and wherein the graphical representation of the received book is disposed at a location on the graphical book map based on all of the received degrees for the identified tones.

As yet another aspect, the graphical book map includes an identification of a plurality of tones, the identification of each of the tones is disposed at different parts of the graphical book map, and the location of the graphical representation of the received book on the graphical book map is disposed a distance from one identification of one tone based on the received degree of the identified tone of the received book.

As a feature of this aspect, the plurality of tones include light, dark, realistic, fantastic, funny, scary, innocent, and sexy, and the identification of the tones are disposed along a border of the graphical book map.

Various other objects, advantages, features and aspects of the present invention are described below and/or will become readily apparent to those of ordinary skill in the art from the following detailed description of the invention.

### BRIEF DESCRIPTION OF THE DRAWINGS

The following detailed description, given by way of example and not intended to limit the present invention, will best be appreciated in conjunction with the accompanying drawings, wherein like reference numerals denote like elements and parts, in which:

FIG. 1 illustrates the genre map of the present invention;

FIG. 2 illustrates a pop-up window containing information about a selected subgenre;

FIG. 3 illustrates a webpage displayed upon user selection of the “Explore the Map” tab;

FIG. 4 illustrates a zoomed-in portion of a subgenre map;

FIG. 5 illustrates a window showing additional information regarding a book;

FIG. 6 illustrates a window allowing the user to provide the short and full descriptions of the book being made available on the web site;

FIG. 7 illustrates a webpage showing a genre map to enable the user to select the genre and subgenre of the book being made available;

FIG. 8 illustrates a webpage showing a genre map and a pop-up window shown after the user has selected a subgenre of the book being made available;

FIG. 9 illustrates a webpage where the user identifies the primary tone of the book being made available;

FIG. 10 illustrates a slider used by the user to identify the degree of the selected primary tone of the book being made available; and

FIG. 11 illustrates a webpage in which the user identifies the secondary tone of the book being made available.

### DETAILED DESCRIPTION OF CERTAIN EMBODIMENTS OF THE PRESENT INVENTION

The invention is directed to novel techniques of browsing for books in an online environment. The invention particularly is directed to a novel book/literary genre map and novel manners of using the genre map, including adding books/literary works to the genre map (i.e., self-publishing).

As described in detail below, the genre map of the present invention enables individuals to quickly and easily find books/literary works to read. For convenience, the term “book” herein means a written literary work of any size including, for example, fictional works, nonfictional works, poems, and plays, to name just a few. In addition to enabling individuals to find books to read, the genre map and its associated functionality further enables individuals, such as authors, to add new books (including transcripts) to the genre map.

As will be appreciated from the description herein, the genre map of the present invention allows authors to upload new literary works for review and comment by others. A description of the genre map of the present invention and techniques for searching and finding books included within the genre map first is provided, followed by a description of the manner in which authors (or others) upload and classify new literary works, such as manuscripts, for inclusion within the genre map. Then, by enabling authors to uploads new literary works and appropriately classifying such works, the present invention allows new works to be quickly and easily found by readers interested in specific genres.

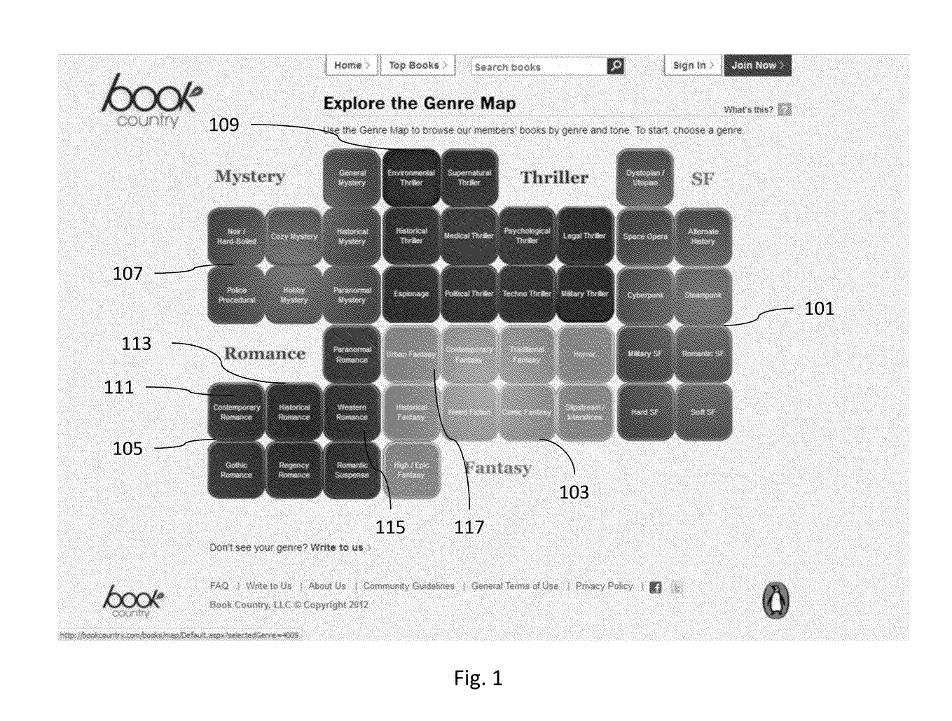

FIG. 1 shows an exemplary genre map in accordance with the present invention. FIG. 1 specifically shows a web page of the Book Country website, which is operated by the assignee hereof. Book Country is a new online environment for genre fiction writers and readers to share and read fiction, give feedback, and discover new books. As is well known, a web page may be displayed on a user's computer monitor, a user's smart phone or other electronic device suitable for accessing and displaying web pages (e.g., the iPad). Since the particular hardware that may be utilized for accessing and displaying web pages is notoriously well known, a detailed description of such hardware is not provided herein.

As shown in FIG. 1, the genre map is structured around five main genres (science fiction 101, fantasy 103, romance 105, mystery 107, and thriller 109), and 42 subgenres. The five main genres preferably are color-coded, such as mystery 107 in light blue, thriller 109 in dark blue, science fiction 101 in green, romance 105 in purple, and fantasy 103 in yellow. Each genre is broken down into distinct subgenres. For example, the romance genre includes the subgenres “Contemporary Romance,” 111 “Historical Romance,” 113 “Western Romance” 115, etc. The other genres likewise are broken down into subgenres.

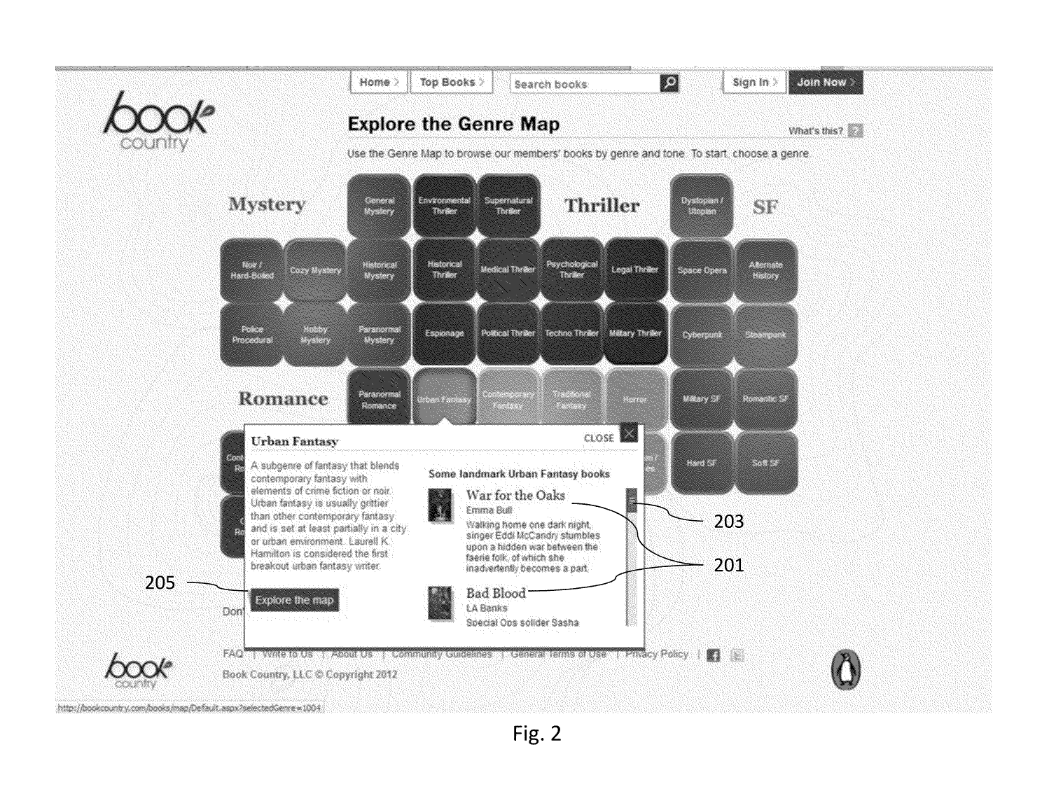

A user viewing the genre map webpage shown in FIG. 1 uses a computer mouse pointer to select a desired subgenre within a particular genre. For example, upon user selection of the subgenre “Urban Fantasy” 117 (within the fantasy genre 103), a window of information about that subgenre pops up, as shown in FIG. 2.

As shown in FIG. 2, the window includes a brief description of the selected subgenre and further provides a list of “landmark books” 201 within the subgenre. As discussed further below, the landmark books, which are well known books that have been editorially chosen and classified, are used to prepopulate the genre map to assist users with their book searches. The window shown in FIG. 2 includes a scroll bar 203 on the right hand side to enable users to view additional landmark books included within the selected subgenre.

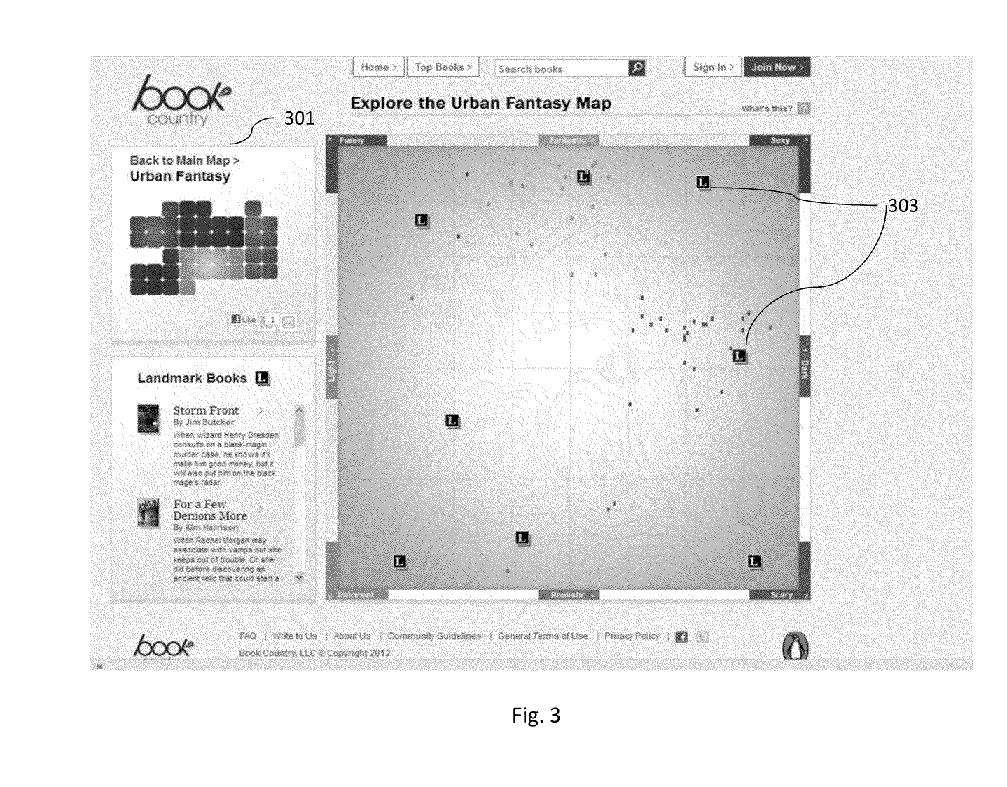

To access the next level of the genre map, the user selects the “Explore the Map” tab 205 within the displayed window. FIG. 3 shows the webpage that is displayed upon user selection of the “Explore the Map” tab.

As shown in FIG. 3, an “Urban Fantasy Map” is presented to the user. The webpage further includes in the upper, left hand corner a reduced-sized version of the genre map (also called “main map”) 301, and includes in the lower, left hand corner the list of the landmark books within the selected subgenre.

The Urban Fantasy Map includes eight descriptor terms disposed along the map's border to further categorize/describe the books included within the urban fantasy subgenre. The descriptor terms (also called “tones”) are light vs. dark, funny vs. scary, innocent vs. sexy, and realistic vs. fantastic. These tones act as compass points to direct a reader's search for his or her next read. Accordingly, the “location” of a particular book within the subgenre map designates how much or how little that book relates to a particular descriptor term as a function of how close or how far the book location is to the descriptor term.

The Urban Fantasy Map further identifies locations of the landmark books within the subgenre using the legend “L” for each landmark book. As shown, the Urban Fantasy Map includes eight “L” legends (including two “L” legends 303), corresponding to eight different landmark books within that subgenre. The list of landmark books identifies the title and a brief description of each of those books.

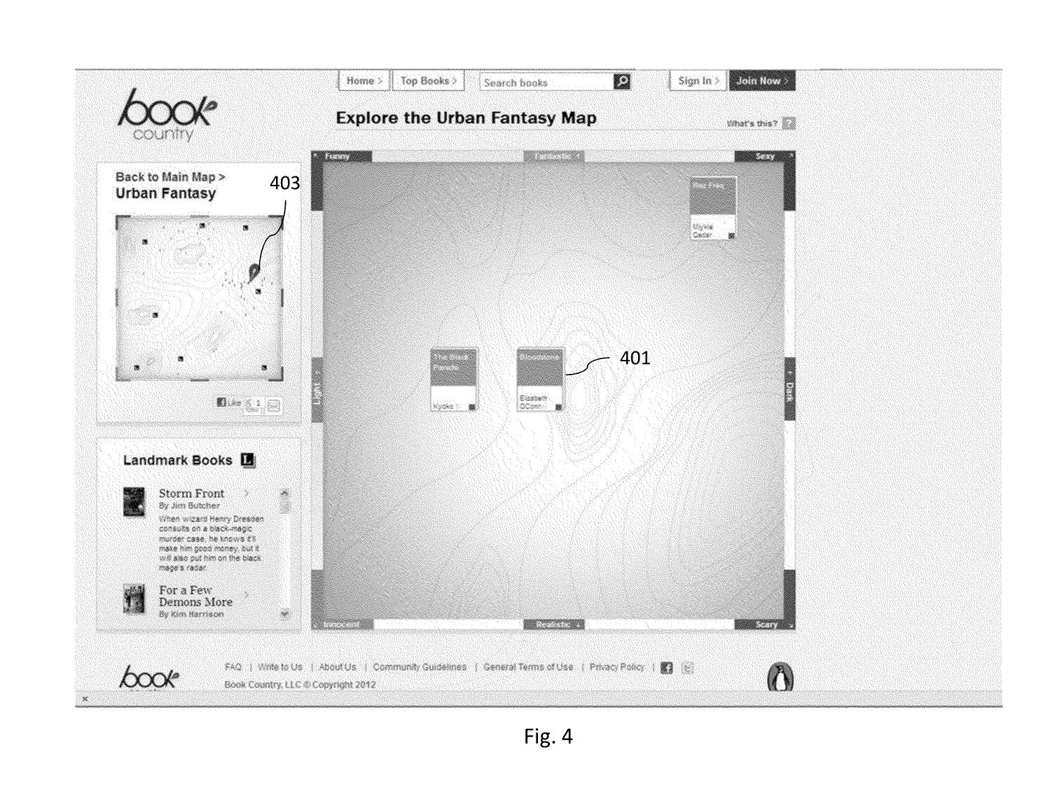

The user may navigate the Urban Fantasy Map, as well as all other sub-maps (i.e., maps of the other subgenres), in various ways. The user may, using the computer mouse pointer, select any position of the Urban Fantasy Map to zoom-in on that selected position. Selection on a position within the map (e.g., via a mouse click) reveals a zoomed-in portion of the map, such as shown in FIG. 4.

Once zoomed in, books within the zoomed-in map are clearly identified by title and author. Other information optionally may be included. In addition, the web page shown in FIG. 4 includes a reduced-size version of the entire Urban Fantasy Map (shown in the upper, left hand corner of the webpage). The location being viewed in the zoomed-in map is identified within the Urban Fantasy Map with a pointer 403. At this point, the user may further navigate within the Urban Fantasy Map or select one of the books that is displayed within the zoomed-in map.

To further navigate the map, the user has several options. The user can click one of the descriptor terms to cause the zoomed-in map to move a short distance in the direction of the selected descriptor term. The user can manually “slide” along the map by placing the mouse pointer within the zoomed-in map, holding the mouse button and then moving the mouse. The user can also select a different position within the Urban Fantasy Map (the reduced-size map in the upper, left hand corner) to zoom in at the selected location. Still further, the user can select one of the listed landmark books to zoom in at the location within the map of the selected book.

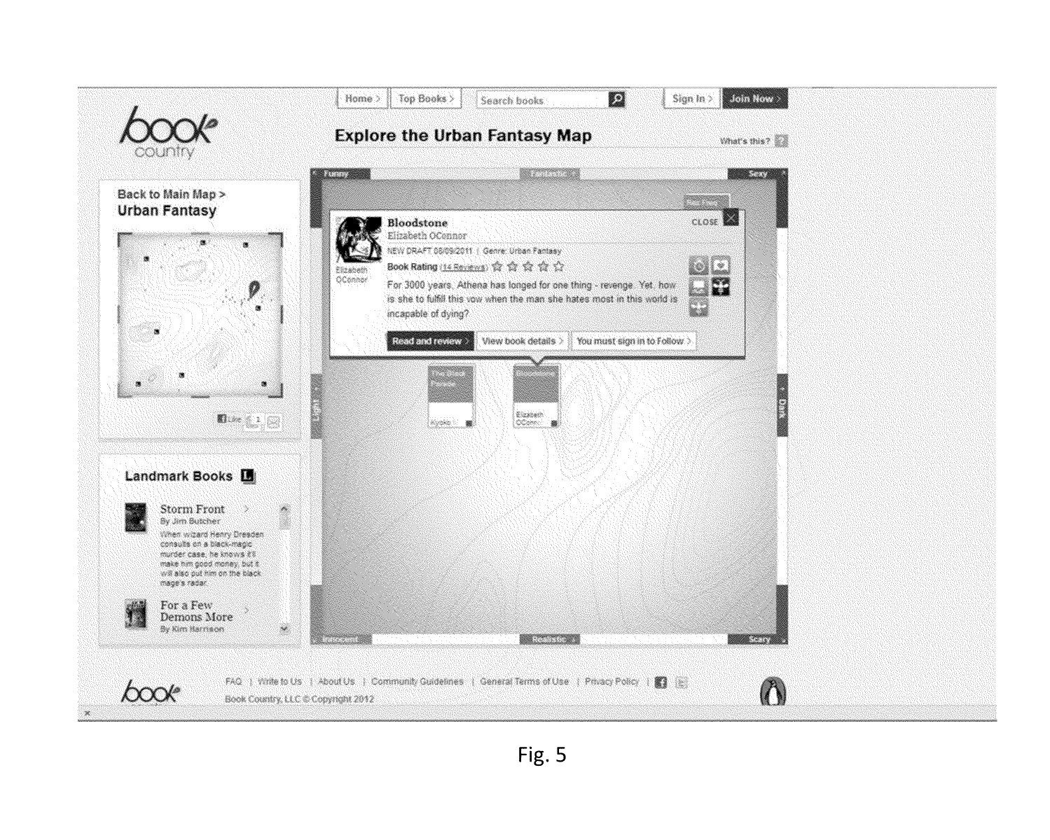

Hence, a user of the genre map of the present invention is able to quickly and easily navigate any selected subgenre map in various manners in order to quickly and easily find a book with desired characteristics. The user then selects a book that is displayed within the zoomed-in map to reveal additional information about the selected book. For example, if the user selects the book “Bloodstone” 401 shown in FIG. 4 (e.g., using the computer mouse), a window showing additional information is provided, as shown in FIG. 5.

The user now may read the selected book and, if desired, review it, and/or simply view detailed information about the book.

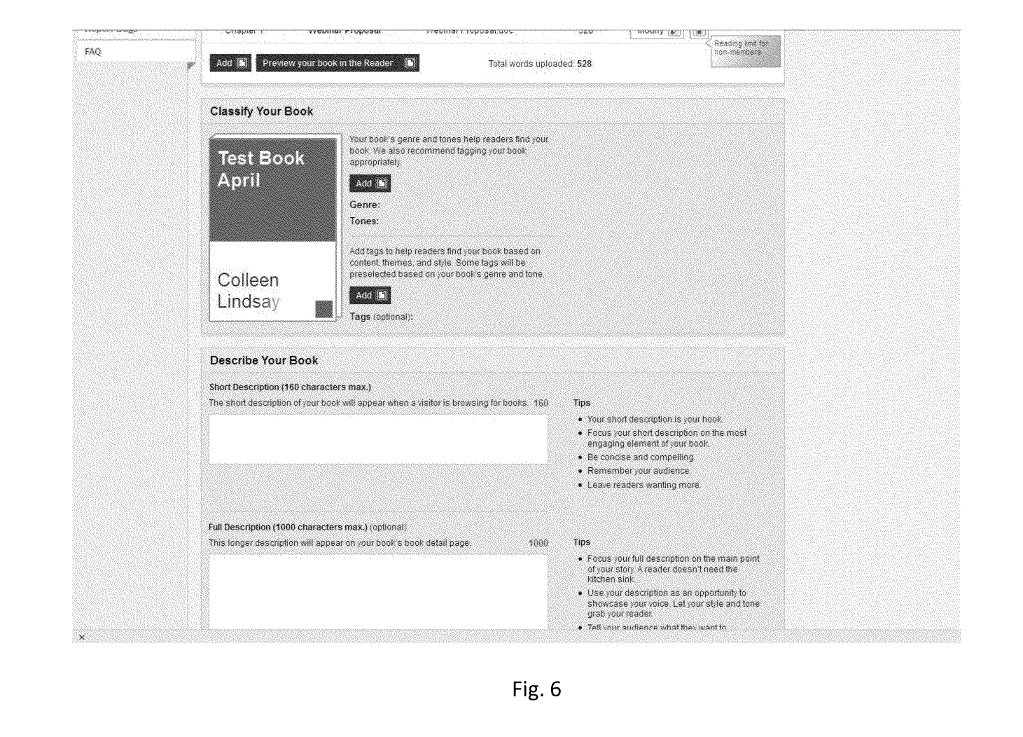

In addition to enabling users to easily find books to read, the present invention enables individuals to add books to the genre map to allow others to read/review the book. FIGS. 6-11 show webpages that are used to enable a user to upload a book and to properly place the uploaded book within the genre map so that readers can find it.

As shown in FIG. 6, the user (e.g., the author of the book) provides short and full descriptions of the book.

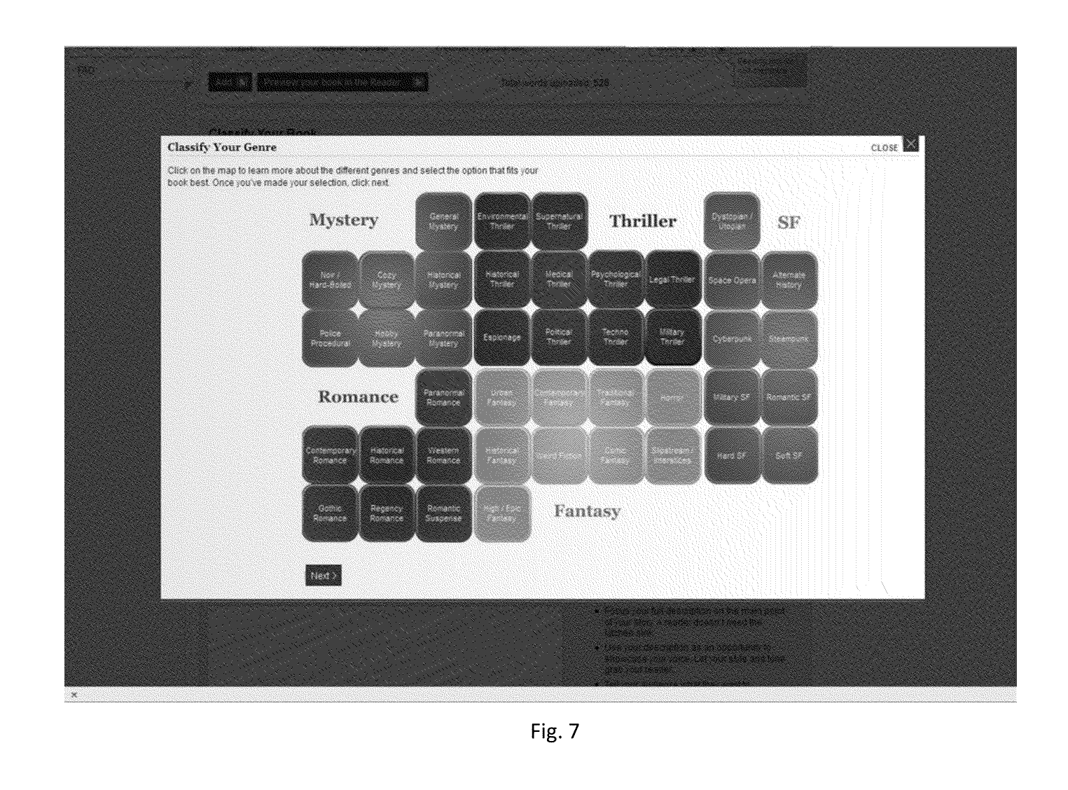

Then, the genre map shown in FIG. 7 is presented to the user to enable the user to select the genre and subgenre of the book.

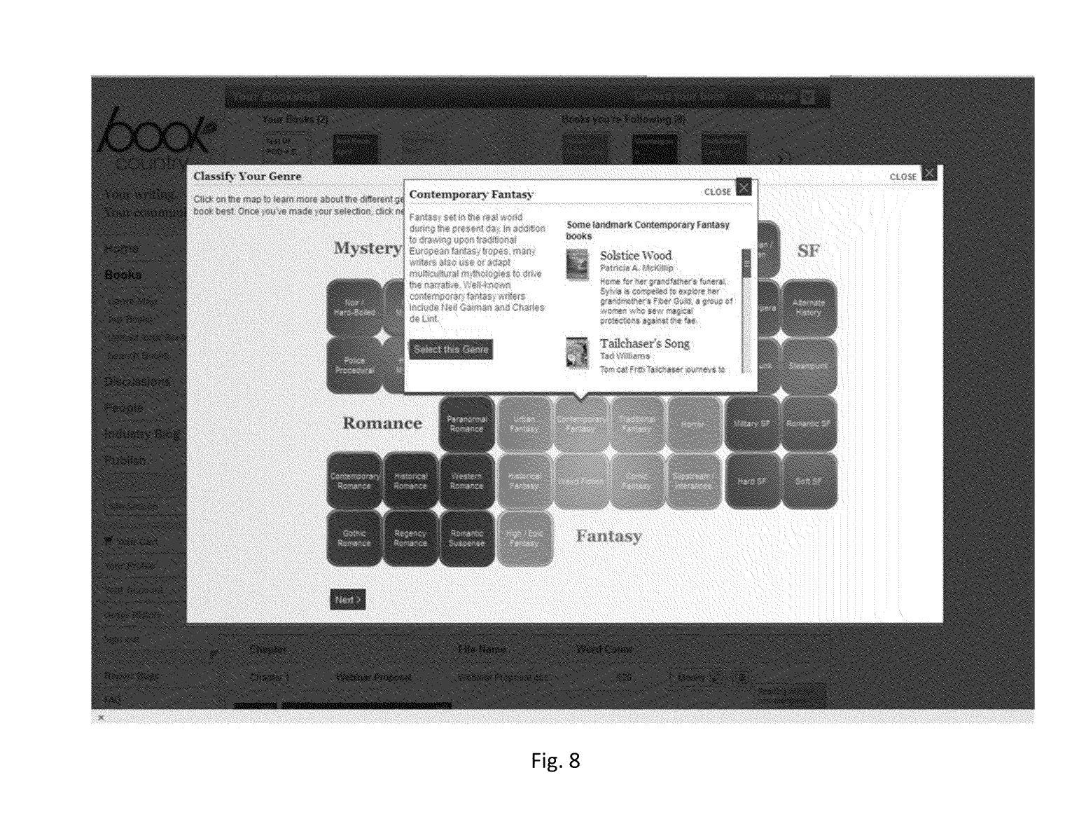

The user selects a subgenre to learn of what the selected subgenre is about and to see a list of landmark books that are associated with that subgenre, as shown in FIG. 8. The user can select other subgenres to learn about those other subgenres. Then, when the user believes that a selected subgenre is appropriate for the book, the user clicks the “Select this Genre” tab.

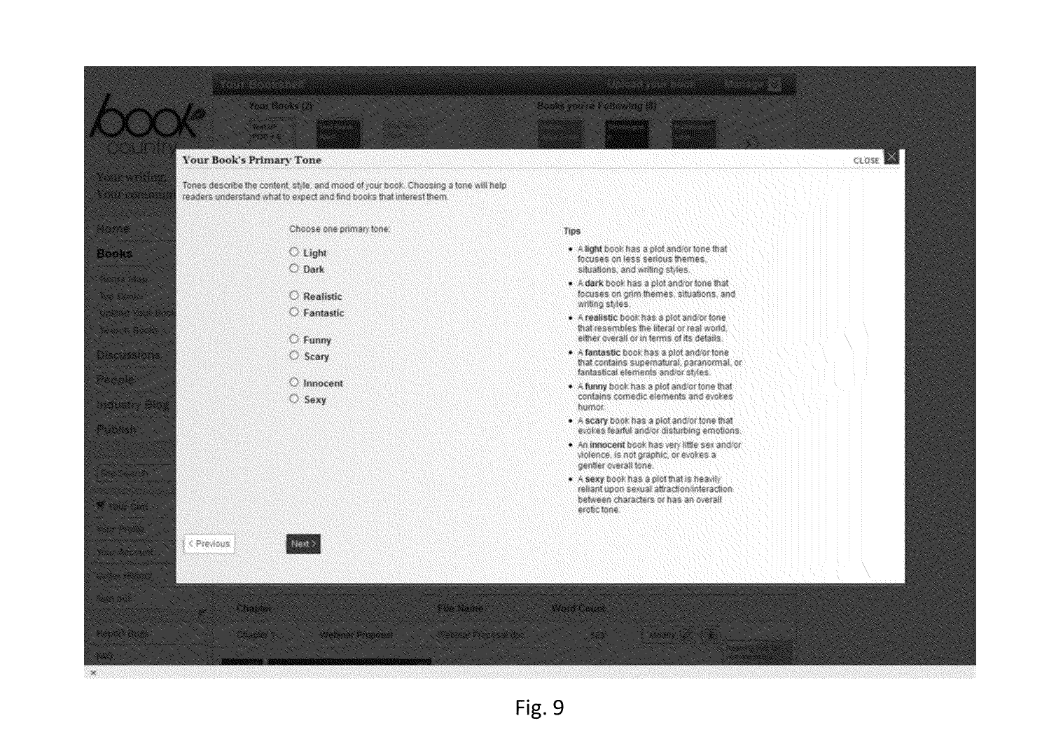

Upon selecting a particular subgenre, the user identifies the primary tone of the book, using the webpage shown in FIG. 9.

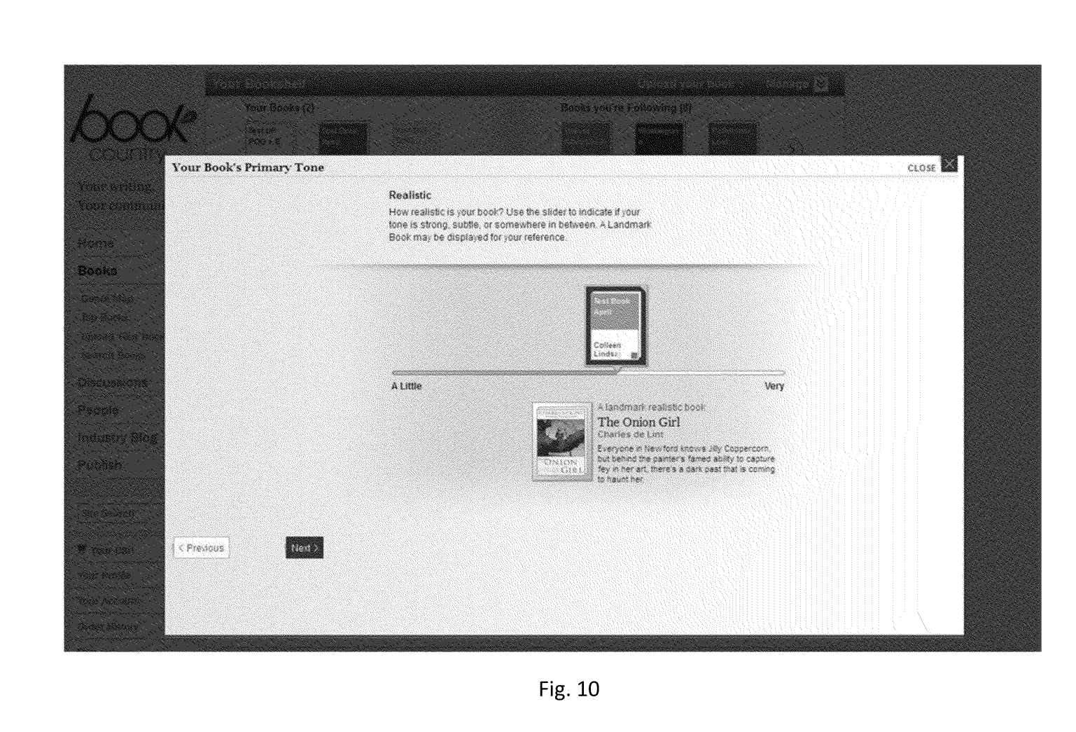

After selecting the primary tone of the book, the user identifies the degree of the selected primary tone using the slider shown in FIG. 10. If one or more landmark books within the selected genre have the same primary tone, those landmark books may be displayed to guide the user.

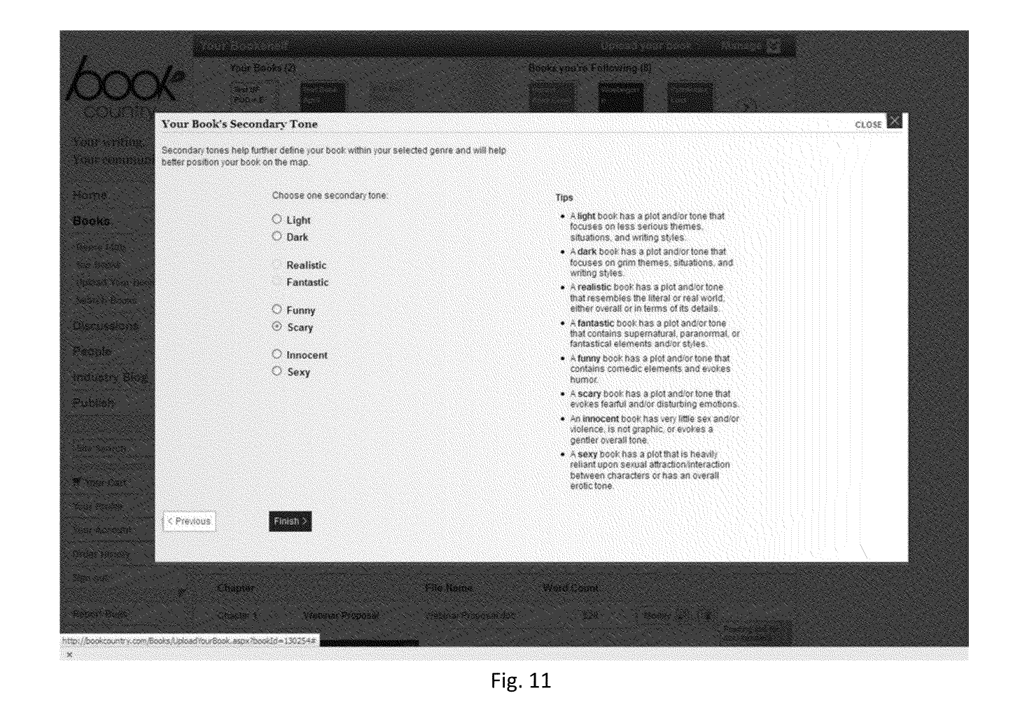

The user then identifies the secondary tone of the book, using the webpage shown in FIG. 11.

After selecting the appropriate genre/subgenre and identifying the primary and secondary tones of the uploaded book, the book is added to the genre map so that others are able to find the book.

As is appreciated from the description herein, the genre map of the present invention provides readers and authors with unique capabilities to find books of particular interest, and to upload books for subsequent finding and reading by others.

In the description and figures herein, the subgenre urban fantasy was selected and discussed, but it is appreciated that the other subgenres operate in the same manner. Each subgenre includes its own set of landmark books, which are appropriately placed within the subgenre maps for ease of reference by users of the present invention.

Moreover, 8 descriptor terms have been provided, but other appropriate descriptor terms may be used. Descriptor terms can be the same throughout all of the subgenres or different.

The specific genres and subgenres discussed and shown in the figures are exemplary and other genres and subgenres may be used. Five genres are described, but a different number of genres may be used within the genre map.

Moreover, the present invention is described in the context of a website. Since the operation of websites and access thereto via the Internet using web browser programs are well known, a discussion of access to websites is not provided herein. Since it is well within the ability of one of ordinary skill in the art to generate suitable code for a website that carries out the present invention, given the description herein, exemplary code is not provided.

The present invention may be employed as an “app” for a suitable electronic device, such as a computer, smart phone (e.g., the iPhone, Android), or tablet-type device (e.g., the iPad).

Having described the invention in detail, the invention in summary pertains to a process of providing a genre map to users in an online environment in which users select a subgenre from a plural group of subgenres of literary works for subsequent reading or other purpose, displaying to the user a subgenre map showing, in graphical form, each of the books included within the selected subgenre, in which the user is able to move within the displayed subgenre map and to select one of the books included within the subgenre map.

As a feature of this summarized invention, each subgenre map is organized by plural descriptor terms in which books are disposed within each subgenre map based in accordance with the descriptor terms. As a further feature, each subgenre map includes at least one landmark book that is pre-populated within the subgenre map for use as a reference tool to the user in selecting a book. As yet another feature, the invention enables a user to upload a book for inclusion within a selected subgenre map. Other features are as described above.

While the invention has been shown and described with reference to certain embodiments thereof, it will be understood by those skilled in the art that various changes in form and details may be made therein without departing from the spirit and scope of the invention.

Therefore, it is intended that the appended claims be interpreted as including the embodiments described herein, the alternatives mentioned above, and all equivalents thereto.

What is claimed is:

1. A method of displaying an electronic book, comprising:
receiving a degree of an identified tone of a book to be electronically received and placed on a graphical book map;
receiving an electronic copy of the book via an electronic communication;
providing a graphical book map for display on an electronic device, the graphical book map having a graphical representation of the received book disposed at a location on the graphical book map based on the received degree of the identified tone of the book.

2. The method of claim 1, wherein the graphical book map includes graphical representations of other electronic books received via electronic communication, the respective locations of the graphical representations of the other electronic books being based on respective identified degrees of tones of the other electronic books.

3. The method of claim 1, wherein the graphical book map further includes a graphical representation of a well-known book at a location on the graphical book map that is based on a degree of a tone of the well-known book, the graphical representation of the well-known book being different than the graphical representation of the received electronic book.

4. The method of claim 1, comprising receiving an identification of a plurality of tones of the received book and receiving a degree for each of the identified tones of the received book, and wherein the graphical representation of the received book is disposed at a location on the graphical book map based on all of the received degrees for the identified tones.

5. The method of claim 1, wherein the graphical book map includes an identification of a plurality of tones, the identification of each of the tones being disposed at different parts of the graphical book map, and the location of the graphical representation of the received book on the graphical book map being disposed a distance from one identification of one tone based on the received degree of the identified tone of the received book.

6. The method of claim 5, wherein the plurality of tones include light, dark, realistic, fantastic, funny, scary, innocent, and sexy; the identification of the tones being disposed along a border of the graphical book map.

7. The method of claim 1, further comprising:
providing a graphical genre map for display on the electronic device, the graphical genre map including a plurality of book genres;
receiving an identification of a selected one of the book genres;
wherein, in the providing a graphical book map step, the graphical book map provided for display on the electronic device is a graphical book map corresponding to the received, selected book genre.

8. A method of displaying an electronic book, comprising:
providing a graphical genre map for display on an electronic device, the graphical genre map including a plurality of book genres;
receiving an identification of a selected one of the book genres;
providing for display on the electronic device, after receiving the selected book genre, a graphical book map corresponding to the selected book genre, the graphical book map including graphical representations of a plurality of books, each of the graphical representations disposed at a respective location on the graphical book map based on degrees of tones of the respective book; and
receiving a selection of one of the books graphically represented in the graphical book map.

9. The method of claim 8, comprising providing, for display on the electronic device, a description of the selected book.

10. The method of claim 8, wherein the graphical book map further includes a graphical representation of at least one well-known book at a location on the graphical book map that is based on a degree of a tone of the well-known book, the graphical representation of the well-known book being different than the graphical representation of the received electronic book.

11. The method of claim 8, wherein the graphical book map includes an identification of a plurality of tones, the identification of each of the tones being disposed at different parts of the graphical book map, and the location on the graphical book map of the graphical representation of each of the plurality of books disposed a respective distance from the tones based on the respective degrees of the tones of the respective book.

12. The method of claim 8, wherein the plurality of tones include light, dark, realistic, fantastic, funny, scary, innocent, and sexy; the identification of the tones being disposed along a border of the graphical book map.

13. The method of claim 8, wherein the graphical genre map includes a plurality of subgenres for each of the book genres.

14. The method of claim 8, comprising receiving an identification of a selected one of the subgenres of a selected book genre.

15. A method of displaying an electronic book, comprising:
providing a graphical genre map for display on an electronic device viewable by a person desiring to publish an electronic book, the graphical genre map including a plurality of book genres;
receiving, from the person, an identification of a selected one of the book genres;
receiving, from the person, a degree of an identified tone of the electronic book;
receiving, from the person, an electronic copy of the electronic book via an electronic communication;
providing for display on the electronic device a graphical book map having a graphical representation of the received book disposed at a location on the graphical book map based on the received degree of the identified tone of the book;
providing the graphical genre map for display on another electronic device viewable by a reader desiring to find a book to read, the displayed graphical genre map including a plurality of book genres;
receiving, by the reader, an identification of a selected one of the book genres;
providing for display on the another electronic device, after receiving the selected book genre, a graphical book map corresponding to the selected book genre, the graphical book map including graphical representations of a plurality of books, each of the graphical representations disposed at a respective location on the graphical book map based on degrees of tones of the respective book;
receiving, from the reader, a selection of one of the books graphically represented in the graphical book map; and
providing, to the reader, information about the selected book.

16. The method of claim 15, wherein the graphical book map displayed on the another electronic device further includes a graphical representation of at least one well-known book at a location on the graphical book map that is based on a degree of a tone of the well-known book, and provided to assist the reader in finding a book have desired characteristics.
